(19) United States
(12) Patent Application Publication
(10) Pub. No.: US 2024/0229548 A9
(43) Pub. Date: Jul. 11, 2024

(54) FIRE DOOR, FRAME, AND METHOD FOR PRODUCING THE FIRE DOOR

(71) Applicant: Walter Andre, Ernst (DE)

(72) Inventor: Walter Andre, Ernst (DE)

(21) Appl. No.: 18/275,638

(22) PCT Filed: Feb. 3, 2021
(86) PCT No.: PCT/EP2021/052557

§ 371 Date: Aug. 3, 2023

(51) Int. Cl. E06B 5/16; E06B 1/52; E06B 3/70

(52) U.S. Cl. CPC E06B 5/164; E06B 1/52; E06B 3/7015; E06B 2003/703; E06B 2003/704

(57) ABSTRACT

A fire door with a frame for arrangement is provided in a wall opening with an opening plane, at least one fire door leaf to be opened at least in sections along an opening normal of the opening plane for fire-retardant closure of the wall opening, at least one vacuum insulation panel for reducing heat transport through the fire door leaf along the opening normal in a closed state of the fire door, and at least one leaf sealing element which connects the frame to the fire door leaf in a wind-tight manner in a closed state of the fire door. The leaf sealing element defines a leaf sealing plane in a closed state of the fire door, which is arranged parallel to the opening plane. A frame and a manufacturing method for the fire door is also provided.

### CROSS-REFERENCE TO RELATED APPLICATIONS

This application claims priority to PCT Application No. PCT/EP2021/052557, having a filing date of Feb. 3, 2021, the entire contents of which are hereby incorporated by reference.

### FIELD OF TECHNOLOGY

The following relates to a fire door with a frame for arrangement in a wall opening with an opening plane, at least one fire door leaf to be opened at least in sections along an opening normal of the opening plane for fire-retardant closure of the wall opening, at least one thermal insulation panel for reducing heat transport through the fire door leaf along the opening normal in a closed state of the fire door and at least one leaf sealing element which connects the frame to the fire door leaf in a wind-tight manner in a closed state of the fire door. In a closed state of the fire door, the leaf sealing element defines a leaf sealing plane that is arranged parallel to the opening plane.

The following also relates to a frame for a fire door of the aforementioned type and a method for manufacturing a fire door of the aforementioned type.

### BACKGROUND

In buildings with several fire protection sections, the fire protection sections must be separated from each other by fire doors. If there are heated and unheated or cooled and uncooled sections among the fire protection sections, these sections must also be separated from each other in a windproof and thermally insulating manner. This applies in particular to modern low-energy buildings that have, for example, a controlled ventilation system with heat recovery.

To achieve the above separation functions, it has been common practice to provide two doors one behind the other with a fire door and a thermally insulated and windproof door. This results in additional costs for planning, materials and installation, the usable area of the building is reduced, and it is impractical for users of the building to have to open two doors for each passage. Furthermore, in the case of single-action doors, the two doors must open in opposite directions to each other, which further complicates use and is not permissible in an escape route for safety reasons.

An insulating and windproof fire door is known from the publication KR101900052B1. The fire door comprises a main leaf, a second leaf and an intermediate insulation space. Due to the three-layer structure, the fire door is relatively complex to manufacture and thick, which makes the installation and operation of the fire door difficult.

The publication EP2633145B1 describes a hermetic fire door which, like the fire door from KR101900052B1, has a three-layer structure with two leaves and an insulation in between. The fire door is designed to prevent the spread of heat and fluids, especially hot gases, smoke and water, in the event of a fire. No special thermal insulation is described in normal operation.

The publication EP258049B1 describes another fire door with one or two wings, which is very similar in its construction and function to the fire door from EP2633145B1.

### SUMMARY

An aspect relates to a fire door that can be manufactured inexpensively, is easy to install and is versatile and convenient to use.

A fire door according to embodiments of the invention comprise a frame for arrangement in a wall opening with an opening plane, at least one fire door leaf to be opened at least in sections along an opening normal of the opening plane for fire-retardant closure of the wall opening and at least one thermal insulation panel for reducing heat transport through the fire door leaf along the opening normal in a closed state of the fire door.

The frame and/or the fire door leaf can, for example, be designed like a frame and a door leaf of a standard fire door. The fire door leaf can, for example, be mechanically connected to the frame in such a way that a swing door, pivoting door or pivoting-sliding door results, whereby the fire door leaf opens at least on a first section from a closed state of the door along the opening normal.

The fire door fulfils at least the requirements of fire resistance class T30, in particular T60, or T90, according to the German industrial standard DIN 4102.

The fire door comprises at least one leaf sealing element which connects the frame to the fire door leaf in a windproof manner in a closed state of the fire door, wherein the leaf sealing element defines a leaf sealing plane which is arranged parallel to the opening plane in a closed state of the fire door. In the closed state of the fire door, the leaf sealing element prevents an air flow from passing between the fire door leaf and the frame.

In an embodiment, the fire door is placed in a wall opening of an otherwise windtight wall so that the wind tightness of the fire door does not lose its effect due to an airflow passing through the wall itself.

The leaf sealing element may, for example, comprise a sealing tape which is arranged circumferentially, in particular around a passage opening of the fire door. The leaf sealing element may, for example, comprise or consist of an elastomer, in particular a vulcanised natural rubber and/or silicone rubber. The leaf sealing element may be attached to the fire door leaf or to the frame, for example glued and/or clamped thereto.

The thermal insulation panel is attached to a closing side of the fire door leaf that is parallel to the opening plane in a closed state of the fire door. By mounting the thermal insulation panel on the fire door leaf, a conventional fire door leaf can be easily retrofitted with the thermal insulation panel to obtain increased thermal insulation. However, mounting on the fire door leaf has the disadvantage that the thermal insulation panel can easily be damaged during transport, installation or use of the fire door, which could impair the thermal insulation effect.

For the purposes of embodiments of the invention, the opening side is the side of the fire door leaf that moves ahead when the fire door is opened out of the closed state. Accordingly, the side of the fire door leaf that moves forward into the closed state during a closing movement of the fire door is referred to as the closing side. In an embodiment, the at least one thermal insulation panel is fastened to the closing side of the fire door leaf. This has the advantages that the thermal insulation panel does not have to be extended over the frame to achieve a good insulating effect and that the insulating effect is not impaired by hinges connecting the fire door leaf to the frame.

The fire door comprises at least one panel sealing element which connects the frame to the thermal insulation panel in a wind-tight manner in a closed state of the fire door, wherein the panel sealing element defines a panel sealing plane in a closed state of the fire door which is arranged parallel to the opening plane and is spaced from the leaf sealing plane along the opening normal. In the closed state of the fire door, the panel sealing element thus defines an additional sealing plane spaced from the panel sealing plane, whereby the thermal insulation effect of the fire door is substantially increased.

The panel sealing element may comprise, for example, a sealing tape which is arranged in particular circumferentially around a passage opening of the fire door. The panel sealing element may, for example, comprise or consist of an elastomer, in particular a vulcanised natural rubber and/or silicone rubber. The panel sealing element may be attached to the thermal insulation panel or to the frame, for example glued and/or clamped thereto.

The fire door leaf comprises at least one leaf sealing surface which is connected to the at least one leaf sealing element in a wind-tight manner at least in a closed state of the fire door. The thermal insulation panel comprises at least one panel sealing surface which is connected in a wind-tight manner to the at least one panel sealing element at least in a closed state of the fire door. The frame comprises at least one leaf-frame sealing surface which is wind-tightly connected to the at least one leaf sealing element at least in a closed state of the fire door. The frame comprises at least one panel-frame sealing surface which is connected in a wind-tight manner to the at least one panel sealing element at least in a closed state of the fire door. The sealing surfaces are aligned parallel to the opening plane at least in a closed state of the fire door.

By aligning the sealing surfaces parallel to the opening plane when the fire door is closed, the sealing elements between the respective associated sealing surfaces are compressed along the opening normal when the fire door is closed. In contrast, sealing elements between sealing surfaces that are not aligned parallel to the opening plane, in particular along the opening normal, would shear along the opening normal when the fire door is closed, causing considerably higher wear of the sealing elements and thus a reduced service life.

The at least one leaf sealing element is designed to absorb a higher energy than the at least one panel sealing element when the fire door is closed. When the fire door is closed, the leaf sealing element and the panel sealing element impact on the associated sealing surfaces and thereby absorb energy, which is at least partially released to the sealing surfaces. The thermal insulation panel can thus be mechanically damaged and its insulating effect impaired. Therefore, it is advantageous if the leaf sealing element arranged on the fire door leaf, which is usually mechanically more stable than the thermal insulation panel, absorbs more energy than the panel sealing element arranged on the thermal insulation panel.

The at least one leaf sealing element has a higher stiffness and/or is designed to be more deformed during closure than the at least one panel sealing element. As a result, the leaf sealing element absorbs a higher energy during closure than the panel sealing element. For example, the leaf sealing element can be thicker than the panel sealing element so that it comes into contact with the associated sealing surface earlier than the panel sealing element when the fire door is closed.

The fire door comprises at least one connecting element mechanically connecting the frame with the fire door leaf in a movable way, wherein the at least one connecting element comprises a hinge. The at least one connecting element can be stably and securely fastened, for example welded to the fire door leaf without the risk of damaging the thermal insulation panel.

The frame comprises a leaf frame part and a panel frame part spaced from the leaf frame part along the opening normal and thermally decoupled from the leaf frame part by at least one separating means, wherein, at least in a closed state of the fire door, the leaf frame part is connected in a wind-tight manner to the at least one leaf sealing element, and the panel frame part is connected in a wind-tight manner to the at least one panel sealing element.

The at least one release agent comprises, for example, a number of spacers made of a plastic or rubber.

Due to the thermally separated subdivision of the frame along the opening normal into a leaf frame part encompassing the leaf sealing plane and a panel frame part encompassing the panel sealing plane, heat transport through the frame along the opening normal is significantly reduced so that the fire door offers increased thermal insulation.

The fire door comprises at least one wall sealing element for windproof connection of the frame to a wall surrounding the wall opening. In order to enable a wind-tight connection to the wall, the wall has as smooth and closed a surface as possible in the area of the wall opening. The wall sealing element, which may comprise a foil, for example, prevents gases or smoke from passing through between the frame and the wall from one side of the fire door to the other. This improves the thermal insulation effect of the fire door and prevents smoke from entering fire sections of a building that are not affected by a fire.

The wall sealing element is arranged at least in sections between a leaf frame part and a panel frame part of the frame. The wall sealing element can be fastened, for example clamped, particularly easily and securely between the frame parts.

The thermal insulation panel is encased by a sheathing for mechanical stabilization and mechanical protection of the thermal insulation panel at least on one side of the thermal insulation panel facing away from the fire door leaf, on all sides of the thermal insulation panel not facing the fire door leaf. The sheathing may comprise, for example, a trough open towards the fire door leaf, in particular a metal sheet trough, in which the thermal insulation panel is inserted. The sheathing may comprise, for example, a metal sheet and/or a plastic, in particular a non-combustible plastic.

On a side of the fire door leaf facing away from the thermal insulation panel and/or on a side of the thermal insulation panel facing away from the fire door leaf, a decorative panel, non-combustible, is attached for the visual adaptation of the fire door to a place of use of the fire door. The decorative panel may comprise, for example, a metal panel, in particular a steel panel, a plastic panel, a wooden panel and/or a leather panel. The decorative panel allows the fire door to be used in a particularly versatile manner.

If the fire door comprises a decorative panel, the connecting elements, for example hinges, for connecting the fire door leaf to the frame are reinforced compared to usual connecting elements for fire doors to be able to reliably bear the additional weight of the decorative panel.

The thermal insulation panel is non-combustible so that it does not cause an additional fire load on the fire door in the event of a fire.

The thermal insulation panel can, for example, comprise rock wool and/or glass wool as insulation material. A design of the thermal insulation panel as a vacuum insulation panel is desired because it has the advantage over other thermal insulation panels that, due to its low thermal conductivity, sufficient thermal insulation can be achieved with a significantly thinner thermal insulation panel than with other thermal insulation panels. By using a vacuum insulation panel, it is possible to attach the thermal insulation panel to a conventional fire door leaf without making the door leaf excessively thick. As a result, a door with such a door leaf can be integrated into a building in an architecturally simple way and can be operated comfortably.

The vacuum insulation panel comprises a gas-tight evacuated envelope, for example made of at least one metallised plastic film, which prevents gas from entering the vacuum insulation panel, and a porous support core in the envelope. The support core prevents the evacuated envelope from being compressed by an ambient pressure.

The disadvantage of vacuum insulation panels is the high mechanical sensitivity of the envelope. If the envelope of a vacuum insulation panel is damaged, the vacuum breaks down and the thermal conductivity of the vacuum insulation panel increases. Furthermore, common envelopes with plastic films are usually flammable and not resistant to the temperatures generated in a fire, so they cannot be used on a fire door without further ado.

The support core comprises or consists of microporous, in particular fumed, silica. With microporous silica, a very low thermal conductivity can be achieved in the evacuated state of the vacuum insulation panel. Microporous silica has the advantage over other materials, for example plastic foams, microfibre materials or glass fibre materials, that a relatively good insulating effect is still achieved even if the pressure in the vacuum insulation panel increases, so that the vacuum insulation panel can be used over a long period of time. This is particularly advantageous in the case of a permanently installed fire door, which cannot be easily replaced when the thermal insulation deteriorates. In addition, microporous silica is not combustible.

The support core comprises an opacifier to reduce heat transfer by infrared radiation. The opacifier comprises for example carbon black, iron oxide, titanium oxide and/or silicon carbide.

The envelope comprises or consists of at least one metal composite foil. The at least one metal composite foil comprises, for example, a plastic foil which is, for example, vapour-deposited with a metal, in particular with aluminium. The envelope may comprise at least one metal foil, in particular an aluminium foil, and at least one plastic foil enclosing the at least one metal foil. By combining at least one metal foil with at least one plastic foil, a particularly high gas-tightness of the envelope is achieved.

The at least one vacuum insulation panel comprises a plurality of chambers separated from one another in a gas-tight manner, a plurality of, for example 2 to 50, in particular 5 to 25, chambers being arranged next to one another and/or one above the other along the leaf plane and/or a plurality of, for example 2, 3, 4 or 5, chambers being arranged one behind the other along the leaf normal.

Due to the division into chambers, if the envelope is damaged, the entire vacuum insulation panel is not ventilated, but only the chambers affected by the damage. This allows the vacuum insulation panel to ensure sufficient thermal insulation even in a damaged state.

Due to chambers lying next to each other and/or one above the other along the leaf plane, it is possible, for example, to cut out a cut-out for a door handle from the vacuum insulation panel without damaging other areas of the vacuum insulation panel.

By chambers arranged one behind the other along the leaf normal, it is possible, for example, to insert fasteners such as screws for fastening the vacuum insulation panel to the fire door leaf up to a predetermined depth into the vacuum insulation panel without ventilating the entire vacuum insulation panel.

At least one leaf sealing surface for wind-tight connection to the at least one leaf sealing element of the fire door is formed by at least one projection of the fire door leaf over the thermal insulation panel in at least one projection direction parallel to the leaf plane. If the thermal insulation panel does not completely cover the fire door leaf, so that at least one projection of the fire door leaf over the thermal insulation panel is created, this results in the at least one leaf sealing surface in a particularly simple manner.

For example, the fire door leaf can protrude over the thermal insulation panel at a right, left and upper edge of the fire door leaf, so that the respective protrusion forms the leaf sealing surface.

The at least one thermal insulation panel is positively fastened, in particular positively fastened in all directions, with a number of clamps, to the fire door leaf. By a positive fastening, the thermal insulation panel can be held reliably on the fire door leaf without the risk of damaging the thermal insulation panel.

The thermal insulation panel could also be fastened to the fire door leaf with a material bond, for example glued on. However, it has been found that due to the poor ventilation of the contact surface between the thermal insulation panel and the fire door leaf, a stable adhesive bond can only be achieved with a long curing time, which leads to a significantly longer manufacturing time than with a positive fastening.

In an embodiment, the at least one thermal insulation panel comprises at least one recess for a door handle of the fire door. This allows the door handle to be easily mounted without damaging the thermal insulation panel.

A frame according to embodiments of the invention is designed for use in a fire door according to embodiments of the invention. The frame comprises a leaf frame part and a panel frame part spaced from the leaf frame part along the opening normal of the fire door and thermally decoupled from the leaf frame part by a separating means.

The leaf frame part is designed for wind-tight connection to the at least one leaf sealing element of the fire door, and the panel frame part is designed for wind-tight connection to the at least one panel sealing element of the fire door.

Due to the thermally separated subdivision of the frame along the opening normal into a leaf frame part encompassing the leaf sealing plane and a panel frame part encompassing the panel sealing plane, heat transport through the frame along the opening normal is significantly reduced so that the fire door offers increased thermal insulation.

The frame, in particular the leaf frame part, the panel frame part and/or the separating means, can in particular be designed in the same way as the frame of the fire door according to embodiments of the invention described above, resulting in the advantages mentioned therein.

A method according to embodiments of the invention is adapted for manufacturing a fire door according to embodiments of the invention. In an embodiment, the method comprises at least providing a fire door leaf and fastening at least one thermal insulation panel on a closing side of the fire door leaf lying parallel to a leaf plane of the fire door leaf for reducing a heat transport through the fire door leaf perpendicular to the leaf plane.

In an embodiment, the method can in particular be designed as described above in connection with the fire door according to embodiments of the invention, which results in the advantages mentioned there.

The fastening comprises a positive fastening, in particular a positive fastening in all directions, for example with a number of clamps. By a positive fastening, the thermal insulation panel can be reliably held to the fire door leaf without the risk of damaging the thermal insulation panel.

### BRIEF DESCRIPTION

Some of the embodiments will be described in detail, with references to the following Figures, wherein like designations denote like members, wherein:

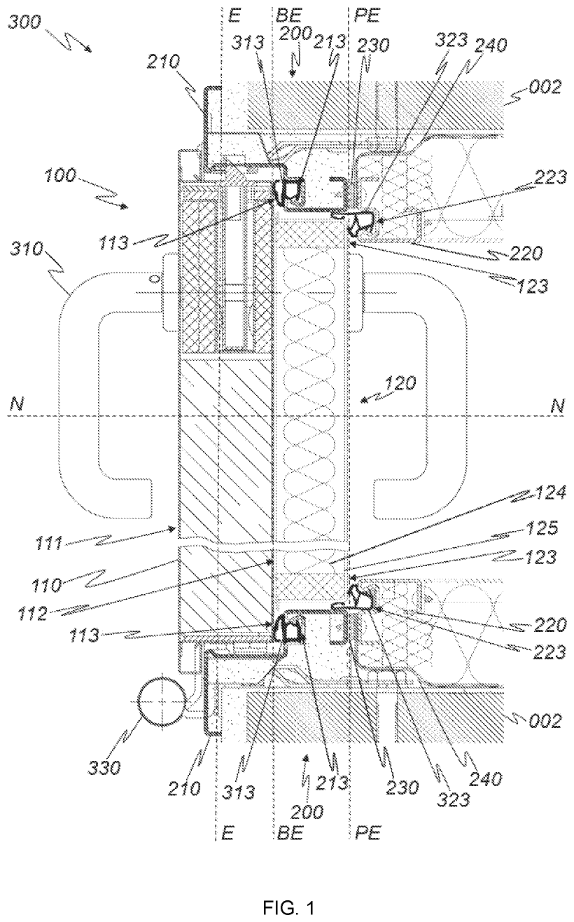

FIG. 1 shows a horizontal section of an embodiment of a fire door according to embodiments of the invention.

### DETAILED DESCRIPTION

FIG. 1 shows a horizontal section of an embodiment of a fire door 300 according to embodiments of the invention. The fire door 300 shown in a closed state comprises a frame 200, which is arranged in a wall opening of a wall 002 with an opening plane E. The fire door 300 is equipped with an opening frame 200.

The illustrated fire door 300 comprises a fire door leaf 110 for fire-retardant closure of the wall opening, wherein the fire door leaf 110 can be opened at least in sections along an opening normal N of the opening plane E. The fire door leaf 110 can, for example, be designed like a door leaf of a standard fire door.

The frame 200 is mechanically connected to the fire door leaf 110 in a movable way, for example, via a number of connecting elements 330, in particular hinges. The fire door 300 is designed as a hinged door, for example, so that the fire door leaf 110 can first be opened along the opening normal N from the illustrated closed state of the fire door 300.

The illustrated fire door 300 comprises at least one vacuum insulation panel 120 for reducing heat transport through the fire door leaf 110 along the opening normal N in a closed state of the fire door 300. The vacuum insulation panel 120 is, for example, fastened, in particular positively fastened, to a closing side 112 of the fire door leaf 110, which is parallel to the opening plane E in a closed state of the fire door 300.

The fire door leaf 110 and the vacuum insulation panel 120 together form a door leaf 100 of the fire door 300.

The illustrated fire door 300 comprises a leaf sealing element 313 which, in the closed state of the fire door 300, connects the frame 200 to the fire door leaf 110 in a wind-tight manner, wherein the leaf sealing element 313, in the closed state of the fire door 300, defines a leaf sealing plane BE which is arranged parallel to the opening plane E.

The fire door leaf 110 comprises a leaf sealing surface 113 that is wind-tightly connected to the leaf sealing element 313 when the fire door 300 is closed. The frame 200 comprises a leaf-frame sealing surface 213 which is connected to the leaf sealing element 313 in a wind-tight manner.

The leaf sealing element 313 comprises, for example, a sealing tape extending around a passage opening of the fire door 300, the sealing tape being attached, for example, to the leaf frame sealing surface 213.

The illustrated fire door 300 comprises a panel sealing element 323 which, in the closed state of the fire door 300, connects the frame 200 to the vacuum insulation panel 120 in a wind-tight manner, wherein the panel sealing element 323, in the closed state of the fire door 300, defines a panel sealing plane PE which is arranged parallel to the opening plane E and is spaced from the leaf sealing plane BE along the opening normal N.

The vacuum insulation panel 120 comprises a panel sealing surface 123 that is wind-tightly connected to the panel sealing element 323 when the fire door 300 is closed. The frame 200 comprises a panel frame sealing surface 223 which is connected to the panel sealing element 323 in a wind-tight manner.

The leaf sealing surface 113 is formed by a projection of the fire door leaf 110 over the vacuum insulation panel 120 in at least one projection direction parallel to a leaf plane of the door leaf 100 which is parallel to the opening plane E in the closed state of the fire door 300.

For example, the fire door leaf 110 may protrude over the vacuum insulation panel 120 at a right, left and top edge of the fire door leaf 110, respectively, so that the respective protrusion forms the leaf sealing surface 113.

The panel sealing element 323 comprises, for example, a sealing strip extending around a passage opening of the fire door 300, which sealing strip is attached, for example, to the panel frame sealing surface 223.

The sealing surfaces 113, 123, 213, 223 are aligned parallel to the opening plane E when the fire door 300 is closed.

In an embodiment, the frame 200 comprises a leaf frame part 210 and a panel frame part 220 spaced along the opening normal N from the leaf frame part 210 and thermally decoupled from the leaf frame part 210 by at least one separating means 230, for example by a number of elastomeric buffers.

The leaf frame part 210 is connected to the leaf sealing element 313 in a wind-tight manner at least when the fire door 300 is closed, and the panel frame part 220 is connected to the panel sealing element 323 in a wind-tight manner at least when the fire door 300 is closed.

The illustrated fire door 300 comprises at least one wall sealing element 240, for example a windproof foil, wherein the wall sealing element 240 connects the frame 200 to the wall 002 in a windproof manner, wherein the wall sealing element 240 is arranged in sections between a leaf frame part 210 and a panel frame part 220 of the frame 200.

The vacuum insulation panel 120, for example designed as a vacuum insulation panel, comprises a support core 124 with fumed silica and an envelope 125 enclosing the support core 124 in a gas-tight manner and comprising a metal foil and a plastic foil. Furthermore, the vacuum insulation panel 120 can be mechanically stabilized and protected by a sheathing, for example a sheet metal trough (not shown), at least on the sides not facing the fire door leaf 110.

The vacuum insulation panel 120 comprises at least one recess for a door handle 310 of the fire door 300.

Although the invention has been illustrated and described in greater detail with reference to the exemplary embodiments, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

### LIST OF REFERENCE SIGNS

BE Leaf sealing plane
E Opening plane
N Opening normal
PE Panel sealing plane
002 Wall
100 Door leaf
110 Fire door leaf
111 Opening side
112 Closing side
113 Leaf sealing surface
120 Vacuum insulation panel
123 Panel sealing surface
124 Support core
125 Envelope
140 Clamp
200 Frame
210 Leaf frame part
213 Leaf frame sealing surface
220 Panel frame part
223 Panel frame sealing surface
230 Separating means
240 Wall sealing element
300 Fire door
310 Door handle
313 Leaf sealing element
323 Panel sealing element
330 Connecting element

1-15. (canceled)

16. A fire door comprising:
a) a frame for arrangement in a wall opening with an opening plane;
b) at least one fire door leaf to be opened at least in sections along an opening normal of the opening plane for fire-retardant closure of the wall opening;
c) at least one vacuum insulation panel for reducing heat transport through the fire door leaf along the opening normal in a closed state of the fire door;
d) at least one leaf sealing element which connects the frame in a wind-tight manner to the fire door leaf in a closed state of the fire door;
e) wherein the leaf sealing element defines a leaf sealing plane in a closed state of the fire door, which is arranged parallel to the opening plane;
f) wherein the vacuum insulation panel is fastened to a closing side of the fire door leaf which is parallel to the opening plane in a closed state of the fire door;
g) wherein the fire door has at least one panel sealing element, which, in a closed state of the fire door, connects the frame in a wind-tight manner to the vacuum insulation panel;
h) wherein, in a closed state of the fire door, the panel sealing element defines a panel sealing plane which is arranged parallel to the opening plane and is spaced from the leaf sealing plane along the opening normal; and
i) wherein the fire door further includes at least one wall sealing element for wind-tight connection of the frame to a wall surrounding the wall opening.

17. The fire door according to claim 16, wherein
a) the fire door leaf further comprises at least one leaf sealing surface which is connected in a wind-tight manner to the at least one leaf sealing element at least in a closed state of the fire door;
c) the vacuum insulation panel further comprises at least one panel sealing surface which is wind-tightly connected to the at least one panel sealing element at least in a closed state of the fire door;
d) the frame further comprises at least one leaf-frame sealing surface which is wind-tightly connected to the at least one leaf sealing element at least in a closed state of the fire door;
e) the frame further comprises at least one panel-frame sealing surface which is connected in a wind-tight manner to the at least one panel sealing element at least in a closed state of the fire door; and
f) wherein the sealing surfaces are aligned parallel to the opening plane at least in a closed state of the fire door.

18. The fire door according to claim 16, wherein
a) the at least one leaf sealing element is configured to absorb a higher energy than the at least one panel sealing element when the fire door is closed; and
b) wherein the at least one leaf sealing element has a higher rigidity and/or is configured to be deformed more strongly than the at least one panel sealing element when it is closed.

19. The fire door according to claim 16, wherein
a) the frame further comprises a leaf frame part and a panel frame part spaced along the opening normal from the leaf frame part and thermally decoupled from the leaf frame part by at least one separating means; and
b) wherein, at least in a closed state of the fire door, the leaf frame part is connected in a wind-tight manner to the at least one leaf sealing element, and the panel frame part is connected in a wind-tight manner to the at least one panel sealing element.

20. The fire door according to claim 19, wherein the wall sealing element is arranged at least in sections between the leaf frame part and the panel frame part of the frame.

21. The fire door according to claim 16, wherein the vacuum insulation panel is sheathed, at least on a side of the vacuum insulation panel facing away from the fire door leaf, by a sheathing for mechanical stabilization and for mechanical protection of the vacuum insulation panel.

22. The fire door) according to claim 16, wherein the vacuum insulation panel further comprises:
a) at least one support core with fumed silica; and
b) at least one envelope with a metal composite foil enclosing the support core in a gas-tight manner.

23. The fire door according to claim 16, wherein the vacuum insulation panel further comprises a plurality of chambers separated from one another in a gas-tight manner, a plurality of chambers being arranged next to one another along the plane of the leaf and/or a plurality of chambers being arranged one behind the other along the normal to the leaf.

24. The fire door according to claim 16, wherein at least one leaf sealing surface for wind-tight connection to the at least one leaf sealing element of the fire door is formed by at least one projection of the fire door leaf over the vacuum insulation panel in at least one projection direction parallel to the leaf plane.

25. The fire door according to claim 16, wherein the at least one vacuum insulation panel is positively attached to the fire door leaf.

26. The fire door according to claim 16, wherein on a side of the fire door leaf facing away from the vacuum insulation panel and/or on a side of the vacuum insulation panel facing away from the fire door leaf, a decorative panel is provided for visually adapting the fire door to a place of use of the fire door.
